(19) United States
(12) Patent Application Publication
(10) Pub. No.: US 2006/0108959 A1
(43) Pub. Date: May 25, 2006

(54) Drive arrangement for activating the hatch of a motor vehicle

(75) Inventors: Mehmet Gueler, Recklinghausen (DE); Andreas Heinrich, Heiligenhaus (DE)

Correspondence Address: ROBERTS, MLOTKOWSKI & HOBBES, P. O. BOX 10064, MCLEAN, VA, 22102-8064, US

(73) Assignee: Brose Schliesssysteme GmbH & Co. KG, Wuppertal (DE)

(21) Appl. No.: 11/257,394

(22) Filed: Oct. 25, 2005

(30) Foreign Application Priority Data
Oct. 25, 2004 (DE) 20 2004 016 543.0

(51) Int. Cl. H02H 7/08; H02P 7/00

(52) U.S. Cl. 318/445

(57) ABSTRACT

A drive arrangement that is an economical structure that makes optimum use of existing installation space is achieved by a drive arrangement, for actuating the hatch of a motor vehicle that is coupled to the body of the motor vehicle to pivot around a hatch axis opening and closing a hatch opening of the body, of the type having a drive motor and a gearing connected on an output side of the drive motor for producing drive motions and movement of the hatch between an open position and a closed position, the gearing having an actuating element which is pivotable around axis of the actuating element and having a push rod which is coupled to the actuating element with an offset respect to the axis of the actuating element, in which the actuating element axis is arranged essentially perpendicular to the hatch axis.

### BACKGROUND OF THE INVENTION

1. Field of Invention

This invention relates to a drive arrangement for actuating the hatch of a motor vehicle that is coupled to the body of the motor vehicle to pivot around a hatch axis opening and closing a hatch opening of the body, the drive arrangement comprising at least one drive with a drive motor and a gearing connected on an output side of the drive motor for producing drive motions and movement of the hatch between an open position and a closed position, the gearing having an actuating element which is pivotable around an axis of the actuating element and having a push rod which is coupled to the actuating element offset with respect to the axis of the actuating element. Furthermore, the invention relates to a hatch arrangement, especially the rear hatch arrangement of a motor vehicle, with the aforementioned drive arrangement.

2. Description of Related Art

The term “hatch” of a motor vehicle is to be understood comprehensively here. Accordingly, it includes not only a rear hatch, but also the trunk lid, the hood or the cargo space hatch of a motor vehicle, as well as, for example, the side doors or a rising roof, if present. The hatch under consideration is coupled to the body of the motor vehicle to be able to pivot around a pivot axis, by which the hatch opening of the body can be closed.

It should be pointed out that the aforementioned body of the motor vehicle in this description does not include the hatch. The hatch of the motor vehicle is therefore not a component of the body of the motor vehicle here.

Motorized actuation of hatches of a motor vehicle, therefore the motorized opening motion and closing motion, are becoming increasingly important at present for enhancing the ease of operation of a motor vehicle.

A known drive arrangement for motorized actuation of the hatch of a motor vehicle to produce the drive motions necessary for actuating the hatch, hereinafter called the operating motions, (German Patent Application DE 101 17 935 A1 and corresponding to U.S. Patent Application Publication 2004/0090083 A1) has a drive motor with gearing which is connected on the output side of the motor and which is made as a geared spindle drive with a spindle and spindle nut. The spindle nut is coupled to the hatch by way of a reversing lever. The disadvantage in using a spindle-nut transmission is, basically, the high implementation costs, poor durability and especially high wear.

Another known drive arrangement (German Patent Application DE 102 25 581 A1) has a rack and pinion transmission for actuating the hatch of a motor vehicle. The drive motor is located on the hatch near the hatch axis. The rack is pivotably coupled to the body of the motor vehicle relative to the hatch axis and engages the pinion of the drive motor. Here, implementation costs are high and durability is comparatively low.

The known drive arrangement underlying the present invention (International Patent Application Publication WO 00/68538 A1 corresponds to U.S. Pat. No. 6,711,855) has a drive which is located on the C pillar of the motor vehicle, with a drive motor and a downstream gearing, the gearing having an actuating element which can be pivoted around the axis of the actuating element, and a push rod. The push rod is coupled to the actuating element offset with respect to the axis of the actuating element, on the one hand, and on the other, is coupled to the hatch offset with respect to the hatch axis. The push rod is coupled to the hatch in the area in which a gas pressure damper (which is ordinarily present) makes contact. The axis of the actuating element is aligned essentially parallel to the hatch axis. The push rod is pivotably coupled to the hatch and to the actuating element in each case. The disadvantage of this known drive arrangement is the fact that the drive can only be located in the area of the C pillar, and thus, “consumes” valuable cargo space.

### SUMMARY OF THE INVENTION

A primary object of the present invention is to embody and develop the known drive arrangement such that an economical structure is ensured with optimum use of the existing installation space.

The aforementioned object is achieved by a drive arrangement of the initially mentioned type in which the actuating element axis is arranged essentially perpendicular to the hatch axis.

First of all, it has been recognized that a certain minimum extension of the actuating element in the plane perpendicular to the axis of the actuating element—the actuating element plane—is essential to be able to ensure the functionally necessary offset coupling of the push rod to the actuating element. Furthermore, it has been recognized that, in a motor vehicle, there is ordinarily enough installation space in planes parallel to the hatch axis. This relates especially to the area of the rear roof frame on the body or the area near the hatch axis on the hatch.

Therefore, an alignment of the actuating element axis essentially perpendicular to the hatch axis enables the actuating element to be located where there is, conventionally, the corresponding installation space in a motor vehicle.

With the approach in accordance with the invention, it is accepted that the coupling of the push rod, at this point, requires two degrees of freedom of motion. This is necessary since the two coupling points of the push rod in an actuation motion are now moved on paths around the pivot axes which are each perpendicular to one another. In a preferred configuration, for this coupling, there is coupling by way of a ball-and-socket joint or by way of a universal joint.

Preferred configurations of the invention ensure a high driving force which is transmitted by way of the push rod, in any case, when the hatch is in the closed position and when the hatch is in the open position. In particular, when the hatch is in the closed position, this is especially advantageous in that, upon actuation, first the resistance of gas pressure dampers which may be present can be overcome and possible “sticking” of the hatch seal opposes the operating motion.

The approach of the invention allows an arrangement of the drive motor, either on the body of the motor vehicle or on the hatch. However, it is especially preferred if the drive motor, and thus the actuating element, are located in the area of the rear roof frame of the body.

According to another teaching of the invention which has independent importance, the aforementioned object is achieved by a drive arrangement in which the push rod, on the other hand, is coupled to the body offset with respect to the hatch axis, and wherein the actuating element axis is aligned essentially parallel to the hatch axis. This flurther teaching is based on the finding that, on the hatch of a motor vehicle, especially in the area of the hatch axis, there is often unused installation space of considerable size. Then, the above described basic concept with an actuating element and push rod can also be advantageously used if the actuating element axis is aligned essentially parallel to the hatch axis. With a corresponding configuration of the hatch this can, in turn, lead to especially advantageous use of the existing installation space.

According to another teaching which likewise has independent importance, the aforementioned object is achieved by a hatch arrangement

The invention is explained in detail below with reference to the accompanying drawings.

### BRIEF DESCRIPTION OF THE DRAWINGS

FIG. 1 is a side view of the rear of a motor vehicle having a drive arrangement in accordance with the invention with the hatch open,

FIGS. 2a & 2b show the drive arrangement of FIG. 1, partially dismounted, with the hatch half opened, respectively, in a side view and in a top view,

FIGS. 3a & 3b show the drive arrangement of shown in FIG. 1, partially dismounted, with the hatch closed, respectively, in a side view and in a top view,

FIG. 4 is a side view of the rear of a motor vehicle with a drive arrangement in accordance with another aspect of the invention with the hatch open,

FIG. 5 is a view corresponding to that of FIG. 4, but with the hatch half open,

FIG. 6 is a view corresponding to that of FIG. 4, but with the hatch closed,

FIG. 7 is a perspective view of the rear of a motor vehicle with another drive arrangement in accordance with the invention having two laterally arranged drives and with the hatch closed.

### DETAILED DESCRIPTION OF THE INVENTION

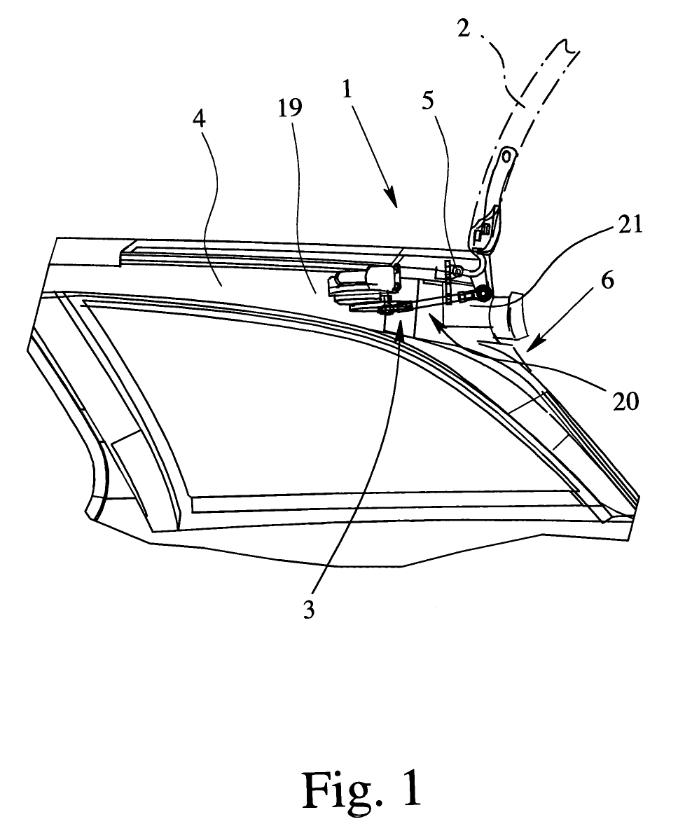

The drive arrangement 1, shown in FIG. 1 in the installed state, is used to operate the hatch 2 of the illustrated motor vehicle, and for this purpose, has a drive 3. Basically, the arrangement 1 can also be provided with several drives 3, preferably two drives 3, for operating the hatch 2.

The hatch 2 is coupled to the body 4 of the motor vehicle to pivot around the hatch axis 5, by which the hatch opening 6 of the body 4 can be opened and closed. It is pointed out that the term “hatch” should be understood comprehensively here, as described above.

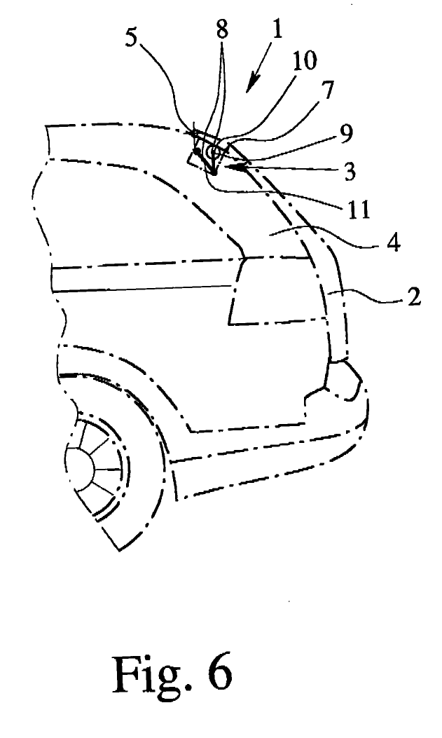

The drive 3 is equipped with a drive motor 7 and with a gearing 8 connected on the output side of the drive motor 7 to produce drive motions. Movement of the hatch 2 between the open position shown in FIG. 1 and a closed position (not shown, but corresponding to that shown for an alternative embodiment in FIG. 6) can be caused by the corresponding drive motion. This drive motion is called an “operating motion” below.

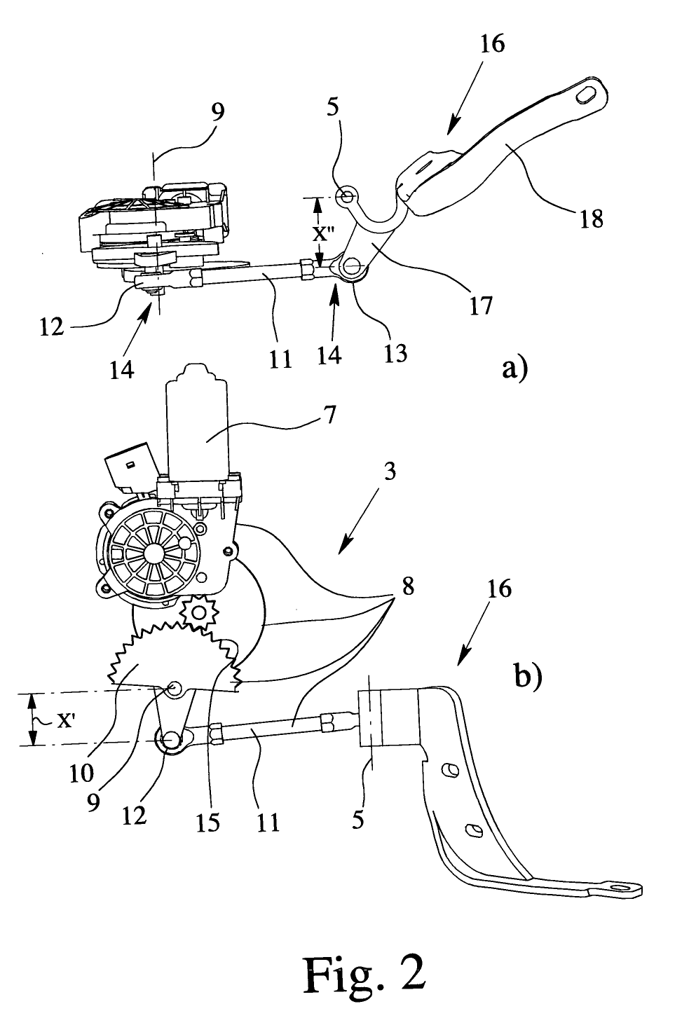

The gearing 8 has an actuating element 10 which can be pivoted around the actuating element axis 9 and a push rod 11 which is assigned to the actuating element 10. On an end 12, the push rod 11 is coupled to the actuating element 10 offset with respect to the axis 9 of the actuating element. On its other end 13, the push rod 11 is coupled to the hatch 2 offset with respect to the hatch axis 5. These offset couplings are illustrated by the offset distances X′, X″ in FIG. 2. The coupling of the push rod 11 to the hatch 2 can take place directly or indirectly by interposition of one or more other elements. The illustrated version which is preferred in this respect is explained in detail below.

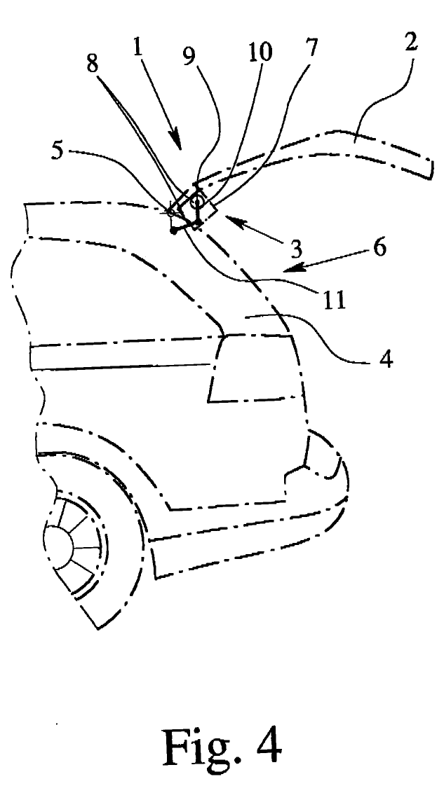

In the embodiment shown in FIG. 1, the drive motor 7 is located on the body 4 so that the actuating element 10 acts on the hatch 2 by way of the push rod 11. However, it can also be provided that the drive motor 7 is located on the hatch 2 and the actuating element 10 acts on the body 4 by way of the push rod 11. Then, the end 12 of the push rod 11, with respect to the axis 9 of the actuating element, is offset coupled to the actuating element 10 and the other end 13 of the push rod 11, with respect to the hatch axis 5, is offset coupled to the body 4. This other possible basic arrangement is implemented in the drive arrangement 1 which is shown in FIGS. 4 to 6 and which is yet to be explained.

For the drive arrangement 1 which is shown in FIGS. 1 to 3 and which is preferred in this regard, it is important that the actuating element axis 9 be aligned essentially perpendicular to the hatch axis 5. In this way, a flat structural shape with simultaneously optimum use of installation space can be achieved. This becomes especially clear in the embodiment shown in FIG. 1.

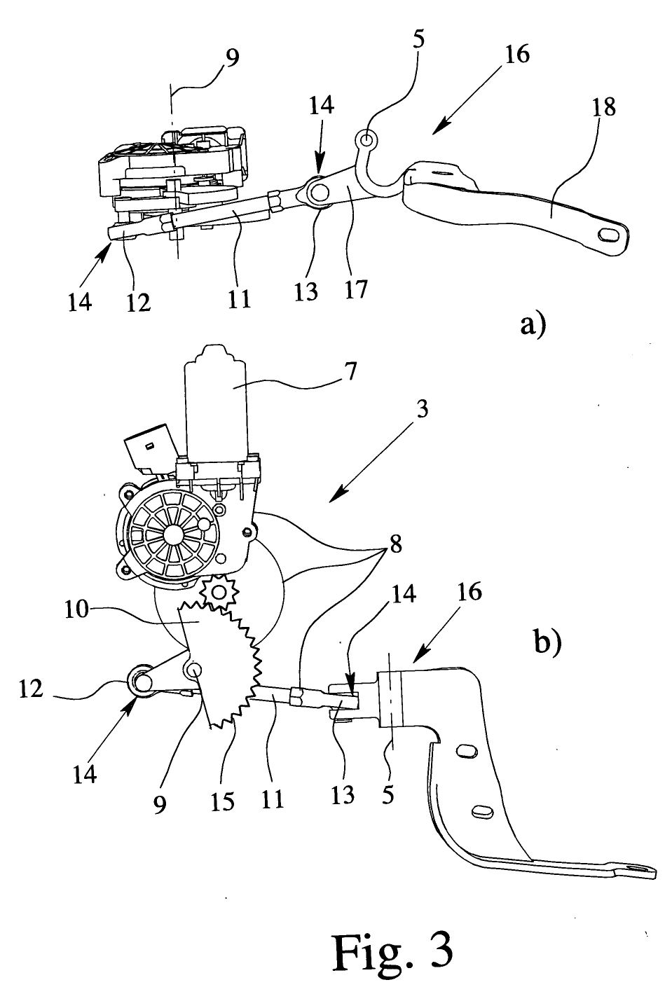

FIGS. 2 & 3 show the drive arrangement 1 in the partially dismounted state with the hatch half opened (FIG. 2a & 2b) and with the hatch 2 closed (FIGS. 3a & 3b). FIGS. 2a & 3a show a side view and FIGS. 2b & 3b show a top view.

In the illustrated embodiment which is preferred in this respect, the coupling of the push rod 11 to the actuating element 10 and/or to the hatch 2 is by way of a ball-and-socket joint 14. Basically, this coupling can take place by way of all types of articulation which allow two degrees of freedom of motion. Other preferred embodiments here are coupling by way of a universal joint or by way of the combination of two pivot hinges which are aligned perpendicular to one another and spaced apart from one another.

The aforementioned considerations relative to the coupling of the push rod 11 can, of course, be applied to the arrangement in which the drive motor 7 is located on the hatch 2.

Here, the design of the gearing 8, especially of the actuating element 10 and of the push rod 11, acquires special importance. This design determines the installation space which is necessary for the drive arrangement 1 and the drive force which acts on the hatch 2 during the driving motion.

For optimum design, it must first be considered that a first dead center position and a second dead center position are assigned to the actuating element 10. When the actuating element 10 is in one of the dead center positions, the movement of the actuating element 10 does not cause movement of the push rod 11 in the direction of its lengthwise axis. During the operating motion, these dead center positions are not reached or traversed. In this respect. the dead center positions in the aforementioned sense are “theoretical” dead center positions.

At this point, the arrangement is such that, with the same driving torque by the drive motor 7 at the start and at the end of the operating motion, especially high driving forces are transmitted by way of the push rod 11. Between these two end positions, the amount of driving force transmitted by way of the push rod 11 passes through a minimum. This is achieved in that, when the hatch 2 is in the closed position, the actuating element 10 is near the first dead center position and/or when the hatch 2 is in the open position, the actuating element 10 is near the second dead center position. The actuating element 10 together with the push rod 11, to a certain extent, form a transmission in the manner of a toggle joint lever mechanism.

In one especially preferred configuration, the actuating element 10, in each of the two end positions, is pivoted by roughly 25° from the respective dead center position. However, here, also other design versions are possible. In the embodiment shown in FIGS. 1 to 3, the operating motion is associated with movement of the actuating element 10 by less than 180°, and preferably, with movement by roughly 130°.

The drive motor 7 is coupled to the actuating element 10 by way of an external teeth 15 which is provided on the actuating element 10. The external teeth 15, preferably forms a toothed segment with an angular extension which corresponds at least to the extent of motion of the actuating element 10 during the operating motion. Here, the toothed segment preferably extends over an angular range of roughly 180°.

FIG. 1 shows that the drive motor 1, in the installed state, can be located especially advantageously on the body 4, preferably in the area of the rear roof frame. This allows optimum use of the flat installation space which is ordinarily present there anyway.

As explained, in the installed state, the drive motor 7 can also be located on the hatch 2, preferably in the area near the hatch axis 5. This configuration is, to a certain extent, complementary to the configuration shown in FIG. 1.

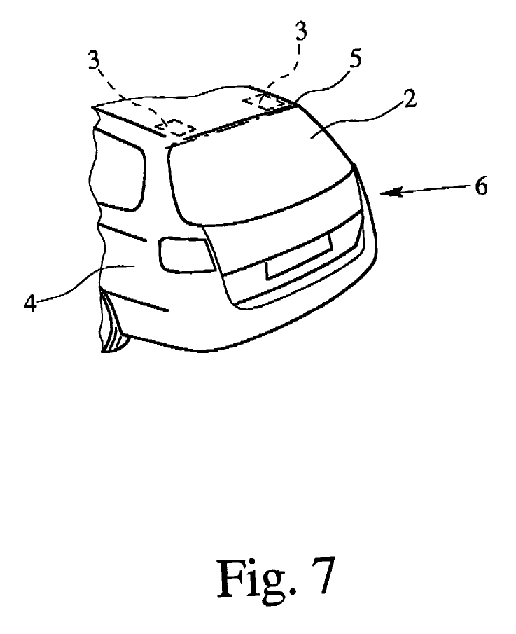

In one especially preferred configuration, in the installed state, the drive motor 7, viewed in the transverse direction of the motor vehicle, is located in the middle area of the motor vehicle. However, basically, a lateral arrangement of the drive motor 7, and thus of the actuating element 10, is possible. For a uniform distribution of force, it can also be provided that there are two drives 3, one on each lateral side and each with a drive motor 7 and gearing 8 connected on the output side of the motor. This is shown in FIG. 7. Then, corresponding mechanical and/or control engineering synchronization of the two drives 3 is possible.

For the embodiment shown in FIGS. 1 to 3, there is a two-arm lever 16 which can be pivoted around the hatch axis 5 for accommodating the drive force of the drive motor 7 which is transmitted by way of the push rod 11. In the installed state, the push rod 11 is coupled to the lever arm 17 and the hatch 2 is attached to the other lever arm 18. However, basically, this lever 16 can also be an integral component of the hatch 2.

The operating motion with the drive arrangement 1 as of the invention is as follows:

Proceeding from the open position of the hatch 2 which is shown in FIG. 1, the actuating element 10 is pivoted around to the right from the FIG. 2b position toward the FIG. 3b position. This causes a lowering of the hatch 2 via the position which is shown in FIG. 2a into the position which is shown in FIG. 3a.

Comparison of FIGS. 2a, 2b with FIGS. 3a, 3b shows that the push rod 11 is pivoted relative to the actuating element 10 not only in the plane of the actuating element, but also perpendicular to it. For this purpose, the above addressed degrees of freedom of motion of the coupling of the push rod 11 relative to the actuating element 10 are necessary. The same, of course, applies to the coupling of the push rod 11 to the hatch 2.

The reverse operating motion, therefore the movement of the hatch 2 from the closed position into the open position, takes place accordingly by movement of the actuating element 10 around to the left from the position of FIG. 3b to that of FIG. 2a . In particular, during opening, the high drive transmission, and thus, the high initial driving force which is transmitted by way of the push rod 11 is advantageous in order to overcome the initial resistance of gas pressure dampers which may be present or the “sticking” of the hatch seal.

Finally, it is pointed out that the drive transmission is likewise high when the hatch 2 is in the open position (FIG. 1) so that the force expenditure to be applied by the drive motor 7 and by a brake which may be present is comparatively low for keeping the hatch 2 in the open position.

Another advantage of the approach in according to the invention with the actuating element 10 and the push rod 11 is that the transmission of force by means of the push rod 11 is not necessarily associated with unloading movements. Thus, it is possible to house the drive motor 7 and the actuating element 10 in a dry space 19 of the motor vehicle and to simply provide a small opening 20 for passage of the push rod 11 into the wet space 21 of the motor vehicle in which the coupling of the push rod 11 to the hatch 2 takes place.

It has already been pointed out that the design of the drive arrangement 1 of the invention is especially important. One especially preferred design version is presented below, but it is not to be taken as limiting.

In the preferred design, the actuating element 10 has a diameter of roughly 94 mm, the push rod 11 being coupled to the outside of the actuating element 10. The coupling of the push rod 11 to the hatch 2 is provided here at a distance of roughly 50 mm away from the hatch axis 5. The effective lever arm of the push rod 11 with respect to the hatch axis 5 is then roughly 32 mm when the hatch 2 is in the closed position. The length of the push rod 11 between the two coupling points is roughly 145 mm. The vertical extension of the drive arrangement 1 without the drive motor 7 is only roughly 25 mm.

The drive arrangement 1 according to another teaching of the invention, which has independent importance, is shown in FIGS. 4 to 6. This drive arrangement 1 also shows the basic principle of a drive 3 with a drive motor 7, actuating element 10 and push rod 11. In this respect, reference is made to the aforementioned details.

It is important here, in any case, that the push rod 11 is offset coupled to the body 4 with respect to the hatch axis 5 and that the actuating element axis 9 is aligned essentially parallel to the hatch axis 5. Coupling of the push rod 11 in the two degrees of freedom of motion is not necessary here.

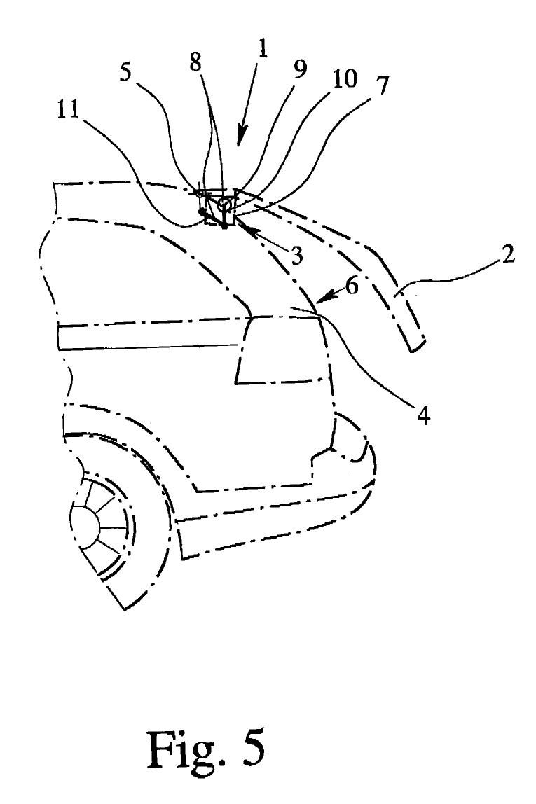

Proceeding from the open position of the hatch 2 which is shown in FIG. 4, the actuating element 10 is moved around to the left in FIG. 4 so that the closed position of the hatch 2 which is shown in FIG. 6 is reached by way of the position shown in FIG. 5.

In the preferred embodiment shown in FIGS. 4 to 6, the drive motor 7, and thus the actuating element 10, are located on the hatch 2 in the area of the hatch axis 5. This is especially advantageous in that this area of the hatch 2 often makes available unused installation space. For the correspondingly present installation space, it is therefore not absolutely necessary to align the actuating element axis 9, as described above, essentially perpendicular to the hatch axis 5. As a result, this leads to especially simple coupling of the push rod 11 to the actuating element 10, on the one hand, and to the body 4, on the other. Basically, the arrangement of the drive motor 7, and thus, of the actuating element 10 in the hatch 2 is associated with the advantage that there is no limitation of the headroom or of the cargo space.

The illustrated embodiments show a push rod 11 which is pressure-loaded when actuated. In place of the push rod 11, basically, also an essentially identically made tie rod can be used. Then, the coupling to the hatch 2 must be adapted accordingly.

In the above described drive arrangements 1, in the drive line of the drive arrangement 1, there can be a clutch so that, in addition to motorized actuation, also manual actuation is possible. In this respect reference should be made to U.S. application Ser. No. 11/143,928 (assigned to the assignee of the present application), the contents of which are hereby fully incorporated by reference into this application. This co-pending application relates to a drive device for the hatch of a motor vehicle with a planetary gearing system in which one of the elements of a sun wheel, planetary gear carrier and internal gear wheel can be braked in order to implement the desired clutch function.

Finally, a further independent teaching relates to a rear hatch arrangement of a motor vehicle which comprises everything which is necessary for achieving the above described advantages. This includes, among others, the hatch 2, the part of the body 4 of the motor vehicle which contains the hatch opening 6, and the above described drive arrangements 1, and relative to which reference should be made to the aforementioned details.

What is claimed is:

1. Drive arrangement for actuating the hatch of a motor vehicle that is coupled to the body of the motor vehicle to pivot around a hatch axis for opening and closing a hatch opening of the body, the drive arrangement comprising at least one drive with:
a drive motor and
a gearing connected on an output side of the drive motor for producing drive motions and movement of the hatch between an open position and a closed position, the gearing having an actuating element which is pivotable around an axis of the actuating element and having a push rod which is coupled to the actuating element with an offset with respect to the axis of the actuating element at one end and is adapted to be offset coupled at a second end to one of the hatch and the body relative to the hatch axis in an installed state,
wherein the actuating element axis is adapted to be arranged essentially perpendicular to the hatch axis in an installed state.

2. Drive arrangement as claimed in claim 1, wherein the coupling of the push rod to at least one of the actuating element, the hatch and the body comprises one of a ball-and-socket joint and a universal joint.

3. Drive arrangement as claimed in claim 1, wherein the actuating element has a first dead center position and a second dead center position; wherein, when the actuating element is in a dead center position, movement of the actuating element does not cause movement of the push rod in a direction of a lengthwise axis of the push rod; and wherein, during operating motion, a dead center position of the actuating element is not reached or traversed.

4. Drive arrangement as claimed in claim 3, wherein the actuating element is adapted to be near the first dead center position when the hatch is in the closed position.

5. Drive arrangement as claimed in claim 3, wherein the actuating element is adapted to be near the second dead center position when the hatch is in the open position.

6. Drive arrangement as claimed in claim 3, wherein the operating motion is associated with movement of the actuating element by less than 180°.

7. Drive arrangement as claimed in claim 1, wherein the actuating element has external teeth which form a toothed segment.

8. Drive arrangement as claimed in claim 1, wherein the drive motor is adapted for being located on the body in a area of a rear roof frame in an installed state.

9. Drive arrangement as claimed in claim 1, wherein the drive motor is adapted to be located on the hatch in an area near the hatch axis in an installed state.

10. Drive arrangement as claimed in claim 1, wherein the drive motor is adapted to be located in a middle area of the motor vehicle, viewed in the transverse direction of the motor vehicle, in an installed state.

11. Drive arrangement as claimed in claim 1, wherein there are two drives and two drive motors, and wherein the motors are adapted to be located on opposite lateral sides of the motor vehicle in an installed state.

12. Drive arrangement as claimed in claim 1, further comprising a two-arm lever which is pivotable around the hatch axis for transmitting the drive force of the drive motor; wherein the push rod is coupled to a first lever arm of the two-arm lever; and wherein a second lever arm of the two-arm lever is adapted to be attached to the hatch in an installed state.

13. Drive arrangement for actuating the hatch of a motor vehicle that is coupled to the body of the motor vehicle to pivot around a hatch axis for opening and closing a hatch opening of the body, the drive arrangement comprising at least one drive with:
a drive motor and
a gearing connected on an output side of the drive motor for producing drive motions and movement of the hatch between an open position and a closed position, the gearing having an actuating element which is pivotable around an axis of the actuating element and having a push rod which is coupled to the actuating element with an offset with respect to the axis of the actuating element at one end;
wherein a second end of the push rod is adapted to be coupled to the body with an offset with respect to the hatch axis in an installed state, and wherein the actuating element axis is adapted to be aligned essentially parallel to the hatch axis in an installed state.

14. Drive arrangement as claimed in claim 13, wherein the actuating element has a first dead center position and a second dead center position; wherein, when the actuating element is in a dead center position, movement of the actuating element does not cause movement of the push rod in a direction of a lengthwise axis of the push rod; and wherein, during operating motion, a dead center position of the actuating element is not reached or traversed.

15. Drive arrangement as claimed in claim 14, wherein the actuating element is adapted to be near the first dead center position when the hatch is in the closed position.

16. Drive arrangement as claimed in claim 14, wherein the actuating element is adapted to be near the second dead center position when the hatch is in the open position.

17. Drive arrangement as claimed in claim 13, wherein there are two drives and two drive motors, and wherein the motors are adapted to be located on opposite lateral sides of the motor vehicle in an installed state.

18. Hatch arrangement of a motor vehicle, comprising:
a hatch opening in a body of the motor vehicle,
a hatch, the hatch being pivotably coupled to the body to pivot around a hatch axis for movement between a closed position in which the hatch opening is closed and an open position in which the hatch opening is opened, and
a drive arrangement for operating the hatch of the motor vehicle, the drive arrangement having at least one drive with a drive motor and with a gearing connected on an output side of the motor to produce drive motions and movement of the hatch between the open position and the closed position, the gearing having an actuating element that is pivotable around the actuating element axis and a push rod, the push rod being coupled at one end to the actuating element with an offset with respect to the axis of the actuating element and at a second end being coupled to one of the hatch and the body with an offset relative to the hatch axis,
wherein the actuating element axis is aligned essentially perpendicular to the hatch axis.

19. Hatch arrangement as claimed in claim 18, wherein the actuating element has a first dead center position and a second dead center position; wherein, when the actuating element is in a dead center position, movement of the actuating element does not cause movement of the push rod in the direction of its lengthwise axis, and wherein, during the operating motion, a dead center position of the actuating element is not reached or traversed.

20. Hatch arrangement as claimed in claim 19, wherein the actuating element is near the first dead center position when the hatch is in the closed position.

21. Hatch arrangement as claimed in claim 19, wherein the actuating element is near the second dead center position when the hatch is in the open position.
